(19) United States
(12) Patent Application Publication
(10) Pub. No.: US 2018/0364035 A1
(43) Pub. Date: Dec. 20, 2018

(54) PARALLELISM CONTROL SYSTEM OF EMISSION LASER LIGHT OPTICAL AXIS AND TARGET TRACKING OPTICAL AXIS

(71) Applicant: CHENGDU ANTI PHOTOELECTRIC TECHNOLOGY CO. LTD, Chengdu (CN)

(72) Inventors: ZHOU LIAO, CHENGDU (CN); YONGGUANG ZHANG, CHENGDU (CN); DELETU MO, CHENGDU (CN)

(73) Assignee: CHENGDU ANTI PHOTOELECTRIC TECHNOLOGY CO. LTD

(21) Appl. No.: 16/008,273

(22) Filed: Jun. 14, 2018

(30) Foreign Application Priority Data
Jun. 16, 2017 (CN) 201710458277.2

(51) Int. Cl. G01B 11/27; F41H 11/02

(52) U.S. Cl. CPC G01B 11/272; F41H 11/02

(57) ABSTRACT

The present invention relates to a parallelism control system of an emission laser light optical axis and a target tracking optical axis, including an optical axis parallelism detection unit, a control unit, a target tracking optical axis correction unit and an emission laser light optical axis correction unit; wherein the optical axis parallelism detection unit is configured to detect the offset amount of the target tracking optical axis and the offset amount of the emission laser light optical axis; the control unit is configured to control the target tracking optical axis correction unit according to the offset amount of the target tracking optical axis, and control the emission laser light optical axis correction unit according to the offset amount of the emission laser light optical axis.

### CROSS-REFERENCE TO RELATED APPLICATIONS

This application claims priority to Chinese Patent Application No. 201710458277.2 with a filing date of Jun. 16, 2017. The content of the aforementioned applications, including any intervening amendments thereto, are incorporated herein by reference.

### TECHNICAL FIELD

The present invention relates to the field of UAV (unmanned aerial vehicle) countermeasures, in particular to a parallelism control system of an emission laser light optical axis and a target tracking optical axis applied to an UAV laser light snipe system.

### BACKGROUND OF THE PRESENT INVENTION

The illegal flying of an UAV (Unmanned Aerial Vehicle) poses a threat to the public safety, flight safety and even air defense security of a country. For example, the UAV is used to steal a photograph, steal information and carry a substance that endangers the public safety, for another example, the occurrence of an UAV dark flight at an airport results in a large number of flights being delayed and causes significant losses.

An UAV laser light snipe system is a (UAV) system that uses laser light to strike a target, In order to hit the target, a target tracking light path and a laser light emission light path can share one light path, that is, striking laser light is transmitted along the target tracking path. Therefore, ensuring that the emission laser light optical axis is parallel to the target tracking optical axis is a premise that the target is accurately stricken.

### SUMMARY OF PRESENT INVENTION

The object of the present invention is to provide a parallelism control system of an emission laser light optical axis and a target tracking optical axis applied to an UAV laser light snipe system. To this end, embodiments of the present invention provide the following technical solutions:

Solution 1: a parallelism control system of an emission laser light optical axis and a target tracking optical axis comprises an optical axis parallelism detection unit, a control unit, a target tracking optical axis correction unit and an emission laser light optical axis correction unit;

the optical axis parallelism detection unit is configured to detect the offset amount of the target tracking optical axis and the offset amount of the emission laser light optical axis;

the control unit is configured to control the target tracking optical axis correction unit according to the offset amount of the target tracking optical axis, and control the emission laser optical axis correction unit according to the offset amount of the emission laser light optical axis;

the target tracking optical axis correction unit is configured to adjust the target tracking optical axis; and

the emission laser light optical axis correction unit is configured to adjust the emission laser light optical axis.

Solution 2: a parallelism control system of an emission laser light optical axis and a target tracking optical axis comprises an optical axis parallelism detection unit, a control unit and a target tracking optical axis correction unit;

the optical axis parallelism detection unit is configured to detect the offset amount of the target tracking optical axis and the offset amount of the emission laser light optical axis;

the control unit is configured to control the target tracking optical axis correction unit according to the offset amount of the target tracking optical axis and the offset amount of the emission laser light optical axis;

the target tracking optical axis correction unit is configured to adjust the target tracking optical axis so that an included angle between the adjusted target tracking optical axis and the emission laser light optical axis is within a set range.

Solution 3: a parallelism control system of an emission laser light optical axis and a target tracking optical axis comprises an optical axis parallelism detection unit, a control unit and an emission laser optical axis correction unit;

The optical axis parallelism detection unit is used for detecting the offset of the target tracking optical axis and the offset of the optical axis of the emitted laser beam;

The control unit is configured to control the emission laser beam axis correction unit according to the target tracking optical axis offset and the emission laser optical axis offset;

The emitting laser optical axis correction unit is configured to adjust the emitting laser optical axis so that an included angle between the target tracking optical axis and the adjusted emitting optical axis is within a set range.

The embodiments of the present invention further provides an optical axis parallelism detection device, comprising a light splitting unit, a retroreflector unit and an optical axis detection sensor unit, wherein the light splitting unit transmits one part of emission laser light to the retroreflector unit, the laser light entering the retroreflector unit is reflected back by a retroreflector, is reflected by the light splitting unit, and then enters the optical axis detection sensor unit to obtain the offset amount of the emission laser light optical axis, tracking light from a target is transmitted through the light splitting unit and then enters the optical axis detection sensor unit to obtain the offset amount of the target tracking optical axis.

The embodiments of the present invention further provides an optical axis parallelism detection device of another structure, comprising a light splitting unit, a retroreflector unit and an optical axis detection sensor unit; the light splitting unit transmits target tracking light to the retroreflector unit, the target tracking light entering the retroreflector unit is reflected back by a retroreflector, is reflected by the light splitting unit, and then enters the optical axis detection sensor unit to obtain the offset amount of the target tracking optical axis; the light splitting unit transmits one part of emission laser light to the optical axis detection sensor unit to obtain the offset amount of the emission laser light optical axis.

Compared with the prior art, the present invention has the following beneficial effects: the optical axis parallelism detection unit can detect an included angle between the emission laser light optical axis and the target tracking optical axis, can correct the included angle via the correction unit when requirements are not met, can ensure parallelism between the emission laser light optical axis and the target tracking optical axis and ensure that the emission laser light can accurately hit a target.

### DESCRIPTION OF THE DRAWINGS

In order to more clearly explain the technical solutions of the embodiments of the present invention, the drawings used in the embodiments will be briefly described below, it should be understood that the following drawings merely illustrate certain embodiments of the present invention and therefore should not be taken as limiting the scope, for a person of ordinary skill in the art, other related drawings may also be obtained according to these drawings without any creative work.

FIG. 1 is a schematic diagram of an optical axis parallelism control system of a structure according to an embodiment of the present invention.

FIG. 2 is a schematic diagram of an optical axis parallelism control system of another structure according to an embodiment of the present invention.

FIG. 3 is a schematic diagram of an optical axis parallelism control system of yet another structure according to an embodiment of the present invention.

FIG. 4 is a schematic diagram of an optical axis parallelism detection unit of a structure according to an embodiment of the present invention.

FIG. 5 is a schematic diagram of an optical axis parallelism detection unit of another structure according to an embodiment of the present invention.

### THE DESCRIPTION OF REFERENCE SIGNS

10—Optical Axis Parallelism Detection Unit; 20—Control Unit; 30—Target Tracking Optical Axis Correction Unit; 40—Emission Laser Light Optical Axis Correction Unit; 50—Target Tracking Light; 60—Emission Laser Light; 101—Light Splitting Unit; 102—Retroreflector Unit; 103—Optical Axis Detection Sensor Unit; 105—Signal Line; 106—One Part Of the Emission Light Reflected By The Light Splitting Unit; 107—One Part Of The Emission Laser Light Transmitted By Light Splitting Unit; 108—Emission Laser Light Reflected By Retroreflector Unit 109—Target Tracking Light Reflected By Retroreflector Unit.

### DETAILED DESCRIPTION OF PREFERRED EMBODIMENTS

The following will clearly and completely describe the technical solutions in the embodiments of the present invention with reference to the accompanying drawings in the embodiments of the present invention, obviously, the described embodiments are only a part of the embodiments of the present invention and not all of the embodiments. The components of an embodiment of the present invention, which are generally described and illustrated in the figures herein, may be arranged and designed in a wide variety of different configurations. Thus, the following detailed description of the embodiments of the present invention provided in the drawings is not intended to limit the scope of the invention as claimed, but is merely representative of selected embodiments of the invention. All other embodiments obtained by those skilled in the art based on the embodiments of the present invention without any creative work fall within the protection scope of the present invention.

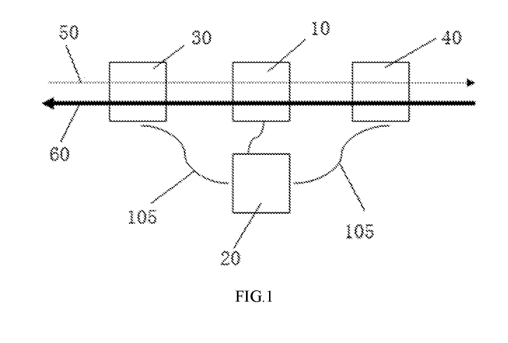

Please refer to FIGS. 1-3, this embodiment provides a parallelism detection system of an emission laser light optical axis and a target tracking optical axis, the system comprises an optical axis parallelism detection unit 10, a control unit 20, a target tracking optical axis correction unit 30, and/or an emission laser light optical axis correction unit 40.

The optical axis parallelism detection unit 10 is configured to detect the parallelism between the target tracking optical axis and the emission laser light optical axis, i.e., an included angle of optical axes. According to the offset amount of the target tracking optical axis and the offset amount of the emission laser light optical axis output from the optical axis parallelism detection unit 10, the control unit 20 performs data processing and fusion, and then controls the target tracking optical axis correction unit 30 and the emission laser light optical axis, respectively, or controls one of the target tracking optical axis correction unit 30 and the emission laser light optical axis correction unit 40 according to an included angle between the target tracking optical axis and the emission laser light optical axis, so that the included angle of the target tracking optical axis and the emission laser light optical axis is within an allowable range, and preferably approaches zero to ensure the parallelism between the emission laser axis and the target tracking optical axis.

The target tracking optical axis correction unit 30 and the emission laser light optical axis correction unit 40 may employ a two-dimensional plane scanning mirror or a system with a two-dimensional plane scanning function consisting of two one-dimensional scanning mirrors, the control unit sends out a control signal to control the target tracking optical axis correction unit 30 and/or the emission laser light optical axis correction unit 40 to perform corresponding angle adjustment so that the included angle between the target tracking optical axis and the emission laser light optical axis is within an allowable range, and preferably approaches zero.

In the solution shown in FIG. 1, a parallelism control system of an emission laser light optical axis and a target tracking optical axis comprises an optical axis parallelism detection unit 10, a control unit 20, a target tracking optical axis correction unit 30 and an emission laser light optical axis correction unit 40, wherein the optical axis parallelism detection unit 10 detects the offset amount of the target tracking optical axis and the offset amount of the emission laser light optical axis, respectively, on the one hand, the control unit 20 controls the target tracking optical axis correction unit 30 according to the offset amount of the target tracking optical axis, and achieves adjustment of the target tracking optical axis, preferably such that the offset amount of the adjusted target tracking optical axis approaches zero, on the other hand, the emission laser optical axis correction unit 40 is controlled according to the offset amount of the emission laser light optical axis, to realize the adjustment of the emission laser light optical axis, preferably such that the offset amount of the adjusted emission laser light optical axis approaches zero.

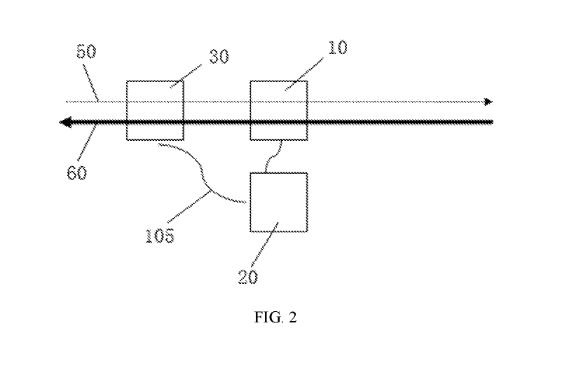

In the solution shown in FIG. 2, a parallelism control system of an emission laser light optical axis and the target tracking optical axis comprises an optical axis parallelism detection unit 10, a control unit 20, and a target tracking optical axis correction unit 30, the optical axis parallelism detection unit 10 detects the offset amount of the target tracking optical axis and the offset amount of the emission laser light optical axis, respectively, the control unit 20 calculates the included angle between the two optical axes according to the two offset amounts, controls the target tracking optical axis correction unit 30, and realizes the adjustment of the target tracking optical axis so that the included angle between the target tracking optical axis and the emission laser light optical axis is within a set range and preferably approaches zero.

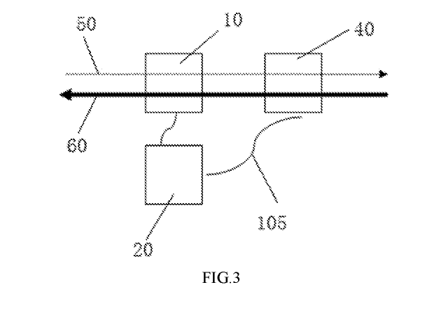

In the solution shown in FIG. 3, a parallelism control system of an emission laser light optical axis and a target tracking optical axis comprises an optical axis parallelism detection unit 10, a control unit 20, and an emission laser light optical axis correction unit 40, the optical axis parallelism detection unit 10 detects the offset amount of the target tracking optical axis and the offset amount of the emission laser light optical axis, respectively, the control unit 20 calculates the included angle between the two optical axes (i.e., the distance between target tracking light and emission laser light optical axis) according to the two offset amounts, and controls the emission laser light optical axis correction unit 40 to achieve the adjustment for the emission laser light optical axis, so that the included angle between the target tracking optical axis and the emission laser light optical axis is within a set range, and preferably approaches a zero optical axis.

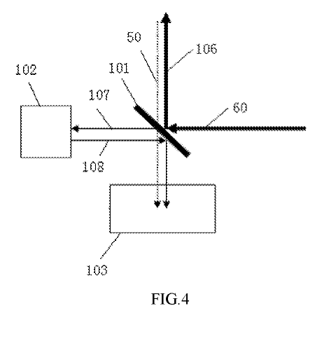

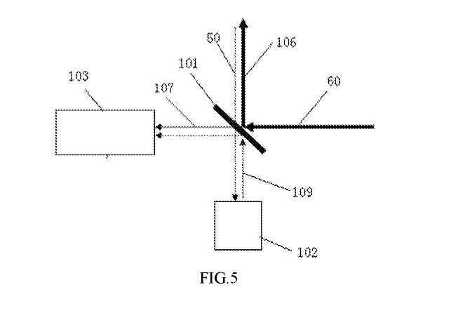

Referring to FIGS. 4-5, the optical axis parallelism detection unit 10 comprises a light splitting unit 101, a retroreflector unit 102, and an optical axis detection sensor unit 103.

In the structure shown in FIG. 4, one surface of the light splitting unit 101 is plated with an optical film having a high reflectance to the emission laser light 60 and an optical film having a high transmittance to the target tracking light 50, the other surface thereof is plated with an optical film having a high transmittance to both the emission laser light 60 and the target tracking light 50. After the emission laser light 60 passes through the light splitting unit 101, one part of the energy, that is, a part of the emission laser light reflected by the light splitting unit 106, is reflected out to strike a target, and the other part of the energy, that is, a part of the emission laser light transmitted by the light splitting unit, passes through the splitting unit 101 and enters the retroreflector unit 102, the laser light entering the retroreflector unit 102 is reflected back, that is, the emission laser light 108 reflected by the retroreflector unit is reflected by the light splitting unit 101 and enters the optical axis detection sensor unit 103 to obtain the offset amount of the emission laser light optical axis; the target tracking light 50 is transmitted through the light splitting unit 101 and then enters the optical axis detection sensor unit 103 to obtain the offset amount of the target tracking optical axis.

In the structure shown in FIG. 5, one surface of the light splitting unit 101 is plated with an optical film that transmits the target tracking light 50 and an optical film having a high reflection to the emission laser light 60, the other surface thereof is plated with the optical film having a high transmittance to both the emission laser light 60 and the target tracking light 50. After the emission laser light 60 passes through the light splitting unit 101, one part of the energy, that is, a part of the emission laser light 106 reflected by the light splitting unit is reflected out to strike the target, and the other part of the energy, i.e., a part of the emission laser light transmitted by the light splitting unit, passes through the light splitting unit 101 and enters the optical axis detection sensor unit 103 to obtain the offset amount of the emission laser light optical axis; the target tracking light 50 passes through the light splitting unit 101 and then enters the retroreflector unit 102, the target tracking light 50 entering the retroreflector unit 102 is reflected back, that is, the target tracking light 109 reflected by the retroreflector unit, is reflected by the light splitting unit 101, enters the optical axis detection sensor unit 103, to obtain the offset amount of the target tracking optical axis.

The retroreflector unit 102 can include one retroreflector, or a retroreflector array consisting of a plurality of retroreflectors.

The above description is only the specific embodiments of the present invention, but the protection scope of the present invention is not limited thereto, any person skilled in the art can easily think of the change or the replacement within the technical scope disclosed by the present invention, and should fall within the protection scope of the present invention.

We claim:

1. A parallelism control system of an emission laser light optical axis and a target tracking optical axis, comprising an optical axis parallelism detection unit, a control unit, a target tracking optical axis correction unit and an emission laser light optical axis correction unit;
the optical axis parallelism detection unit is configured to detect the offset amount of the target tracking optical axis and the offset amount of the emission laser light optical axis;
the control unit is configured to control the target tracking optical axis correction unit according to the offset amount of the target tracking optical axis, and control the emission laser optical axis correction unit according to the offset amount of the emission laser light optical axis;
the target tracking optical axis correction unit is configured to adjust the target tracking optical axis; and
the emission laser light optical axis correction unit is configured to adjust the emission laser light optical axis.

2. The parallelism control system of the emission laser light optical axis and the target tracking optical axis according to claim 1, characterinzed in that the optical axis parallelism detection unit comprises a light splitting unit, a retroreflector unit and an optical axis detection sensor unit, the light splitting unit transmits one part of emission laser light to the retroreflector unit, the laser light entering the retroreflector unit is reflected back by a retroreflector, reflected by the light splitting unit, and then enters the optical axis detection sensor unit to obtain the offset amount of the emission laser light optical axis, tracking light from a target is transmitted through the light splitting unit and then enters the optical axis detection sensor unit to obtain the offset amount of the target tracking optical axis.

3. The parallelism control system of the emission laser light optical axis and the target tracking optical axis according to claim 1, characterized in that the optical axis parallelism detection unit comprises the light splitting unit, the retroreflector unit and the optical axis detection sensor unit, the light splitting unit transmits the target tracking light to the retroreflector unit, the target tracking light entering the retroreflector unit is reflected back by the retroreflector, is reflected by the light splitting unit, and then enters into the optical axis detection sensor unit to obtain the offset amount of the target tracking optical axis, the light splitting unit transmits one part of the emission laser light to the optical axis detection sensor unit to obtain the offset amount of the emission laser light optical axis.

4. The parallelism control system of the emission laser light optical axis and the target tracking optical axis according to claim 2, characterized in that the retroreflector unit comprises one retroreflector, or a retroreflector array consisting of a plurality of retroreflectors.

5. A parallelism control system of an emission laser light optical axis and a target tracking optical axis according to claim 1, comprising an optical axis parallelism detection unit, a control unit and a target tracking optical axis correction unit;
the optical axis parallelism detection unit is configured to detect the offset amount of the target tracking optical axis and the offset amount of the emission laser light optical axis;
the control unit is configured to control the target tracking optical axis correction unit according to the offset amount of the target tracking optical axis and the offset amount of the emission laser light optical axis;
the target tracking optical axis correction unit is configured to adjust the target tracking optical axis so that an included angle between the adjusted target tracking optical axis and the emission laser light optical axis is within a set range.

6. A parallelism control system of an emission laser light optical axis and a target tracking optical axis according to claim 1, comprising an optical axis parallelism detection unit, a control unit and an emission laser optical axis correction unit;
The optical axis parallelism detection unit is used for detecting the offset of the target tracking optical axis and the offset of the optical axis of the emitted laser beam;
The control unit is configured to control the emission laser beam axis correction unit according to the target tracking optical axis offset and the emission laser optical axis offset;
The emitting laser optical axis correction unit is configured to adjust the emitting laser optical axis so that an included angle between the target tracking optical axis and the adjusted emitting optical axis is within a set range.

7. An optical axis parallelism detection device, comprising a light splitting unit, a retroreflector unit and an optical axis detection sensor unit, wherein the light splitting unit transmits one part of emission laser light to the retroreflector unit, the laser light entering the retroreflector unit is reflected back by a retroreflector, is reflected by the light splitting unit, and then enters the optical axis detection sensor unit to obtain the offset amount of the emission laser light optical axis, tracking light from a target is transmitted through the light splitting unit and then enters the optical axis detection sensor unit to obtain the offset amount of the target tracking optical axis.

8. An optical axis parallelism detection device, comprising a light splitting unit, a retroreflector unit and an optical axis detection sensor unit; the light splitting unit transmits target tracking light to the retroreflector unit, the target tracking light entering the retroreflector unit is reflected back by a retroreflector, is reflected by the light splitting unit, and then enters the optical axis detection sensor unit to obtain the offset amount of the target tracking optical axis; the light splitting unit transmits one part of emission laser light to the optical axis detection sensor unit to obtain the offset amount of the emission laser light optical axis.
